(19) United States
(12) Patent Application Publication
(10) Pub. No.: US 2019/0180345 A1
(43) Pub. Date: Jun. 13, 2019

(54) System, Method, and Computer Program Product for Determining Category Alignment of an Account

(71) Applicant: Visa International Service Association, San Francisco, CA (US)

(72) Inventors: Xie Xie, Sunnyvale, CA (US); Debesh Kumar, San Mateo, CA (US); Guangyu Wang, Danville, CA (US); Lawson Lau, Palo Alto, CA (US)

(21) Appl. No.: 15/835,772

(22) Filed: Dec. 8, 2017

(51) Int. Cl. G06Q 30/06; G06Q 30/02; G06F 17/30; G06F 17/16; G06F 17/18

(52) U.S. Cl. CPC G06Q 30/0631; G06Q 30/0269; G06Q 30/0202; G06F 17/18; G06F 17/30035; G06F 17/16; G06F 17/30702

(57) ABSTRACT

Provided is a computer-implemented method for determining a merchant category alignment of an account. The method may include comparing at least one parameter associated with transaction data for each user of a plurality of users; segmenting the plurality of users into at least one group of users based on a similarity of the at least one parameter between each user, generating a merchant category similarity matrix for the at least one group of users based on the transaction data for each user in the at least one group, generating an account category matrix based on the transaction data, generating one or more recommendations of an offer associated with the second merchant category, and communicating the one or more recommendations of an offer associated with the second merchant category. A system and computer program product are also disclosed.

### BACKGROUND OF THE INVENTION

### 1. Field of the Invention

This invention relates generally to systems, devices, products, apparatus, and methods that are used for determining a category alignment of an account, in one particular embodiment, to a system, product, and method for determining a merchant category alignment of an account associated with a user.

### 2. Technical Considerations

A business (e.g., a merchant) may be classified by the type of goods or services provided by the business according to a merchant category. For example, a Merchant Category Code (MCC) (e.g., a four-digit number listed in ISO 18245 for retail financial services) may be used to classify the merchant based on the merchant category of the merchant. A MCC may be assigned based on a type of classification of the merchant (e.g., a type of classification for a hotel, a merchant category for a hotel, a type of classification for an office supply store, a merchant category for an office supply store, and/or the like) and/or by a name of the merchant (e.g., a MCC of 3000 for United Airlines).

In some examples, a MCC may be assigned to a merchant by a transaction service provider (e.g., credit card company) when the merchant first starts accepting credit cards and/or debit cards as a form of payment. Additionally or alternatively, a MCC may be used by a financial institution to determine how to provide loyalty program rewards (e.g., loyalty program points) to a customer that conducts a payment transaction involving a merchant that has the MCC.

However, a financial institution may be unable to accurately determine an alignment between an account (e.g., a credit card account, a debit card account, and/or the like) provided by the financial institution and a merchant category having a MCC in which a customer is likely to conduct a payment transaction using the account. For example, a financial institution may be unable to accurately determine a MCC in which the customer is likely to conduct a payment transaction because the financial institution did not take into consideration that a user did not make purchases at a merchant in a merchant category, did not make purchases at a merchant in a particular merchant category during a time interval of a day, and/or the like. Accordingly, the financial institution may communicate offers to the customer that are ineffective at encouraging the customer to conduct a payment transaction in a merchant category. By communicating offers that are ineffective, network resources and/or processing resources may be wasted as compared to communicating a smaller number of offers that are effective.

### SUMMARY OF THE INVENTION

Accordingly, systems, devices, products, apparatus, and/or methods for determining a category alignment of an account are disclosed that overcome some or all of the deficiencies of the prior art.

According to a non-limiting embodiment, provided is a computer-implemented method for determining a merchant category alignment of an account. The method comprises receiving, with at least one processor, transaction data associated with a plurality of payment transactions involving a plurality of users; comparing, with at least one processor, at least one parameter associated with the transaction data for each user of the plurality of users; segmenting, with at least one processor, the plurality of users into at least one group of users based on a similarity of the at least one parameter between each user of the at least one group of users; generating, with at least one processor, a merchant category similarity matrix for the at least one group of users based on the transaction data for each user in the at least one group, the merchant category similarity matrix comprising a plurality of merchant category similarity scores for the at least one group of users in each merchant category of a plurality of merchant categories, wherein the merchant category similarity scores are based on a determination of how likely each user of the at least one group of users is to conduct a payment transaction in a merchant category of the plurality of merchant categories based on that user conducting a payment transaction in another merchant category of the plurality of merchant categories; generating, with at least one processor, an account category matrix based on the transaction data, wherein the account category matrix comprises a plurality of elements, wherein a plurality of first elements of the account category matrix comprises a number of actual payment transactions by a target user of the at least one group of users using an account identifier associated with an account of the target user in one or more first merchant categories of a plurality of merchant categories during a predetermined time interval, wherein a second element of the account category matrix comprises a number of predicted payment transactions by the target user using the account identifier associated with the account of the target user in a second merchant category of the plurality of merchant categories during the predetermined time interval, and wherein the number of predicted payment transactions is determined based on the number of actual payment transactions by the target user in the one or more first merchant categories, independent of the second merchant category, during the predetermined time interval and a plurality of merchant category similarity scores of the merchant category similarity matrix for the second merchant category, independent of a merchant similarity score corresponding to the second merchant category; generating, with at least one processor, one or more recommendations of an offer associated with the second merchant category; and communicating, with at least one processor, the one or more recommendations of an offer associated with the second merchant category to an issuer system.

According to another non-limiting embodiment, provided is a system for determining a merchant category alignment of an account. The system comprises at least one processor programmed or configured to receive transaction data associated with a plurality of payment transactions involving a plurality of users and a plurality of merchants in a plurality of merchant categories; determine at least one parameter associated with the transaction data for each user of the plurality of users; determine at least one group of users of the plurality users based on determining the at least one parameter; generate a merchant category similarity matrix for the at least one group of users based on the transaction data for each user in the at least one group, the merchant category similarity matrix comprising a plurality of merchant category similarity scores for the at least one group of users in each merchant category of the plurality of merchant categories, wherein the merchant category similarity scores are based on a determination of how likely each user of the at least one group of users is to conduct a payment transaction in a merchant category of the plurality of merchant categories based on that user conducting a payment transaction in another merchant category of the plurality of merchant categories; generate an account category matrix based on the transaction data and the merchant category similarity matrix, wherein the account category matrix comprises a plurality of elements, wherein a plurality of first elements of the account category matrix comprises a number of actual payment transactions by a target user of the at least one group of users using an account of the target user in one or more first merchant categories of the plurality of merchant categories during a predetermined time interval, wherein a second element of the account category matrix comprises a number of predicted payment transactions by the target user using the account of the target user in a second merchant category of the plurality of merchant categories during the predetermined time interval, wherein the number of predicted payment transactions is determined based on the number of actual payment transactions by the target user in the one or more first merchant categories during the predetermined time interval and the plurality of merchant category similarity scores of the merchant category similarity matrix for the second merchant category; generate one or more recommendations of an offer associated with the second merchant category based on generating the account category matrix; and communicate the one or more recommendations of an offer associated with the second merchant category to an issuer system associated with an issuer institution that issued the account of the target user.

According to a further non-limiting embodiment, provided is a computer program product for determining a category alignment of an account. The computer program product comprises at least one non-transitory computer-readable medium including one or more instructions that, when executed by at least one processor, cause the at least one processor to determine at least one parameter associated with transaction data, wherein the transaction data is associated with a plurality of payment transactions involving a plurality of users, wherein determining the at least one parameter comprises determining a value of the at least one parameter for each user of the plurality of users; determine at least one group of users of the plurality users based on the at least one parameter; generate a merchant category similarity matrix for the at least one group of users based on the transaction data for each user in the at least one group, the merchant category similarity matrix comprising a plurality of merchant category similarity scores for the at least one group of users in each merchant category of a plurality of merchant categories, wherein the merchant category similarity scores are based on a determination of how likely each user of the at least one group of users is to conduct a payment transaction in a merchant category of the plurality of merchant categories based on that user conducting a payment transaction in another merchant category of the plurality of merchant categories; generate an account category matrix based on the transaction data, wherein the account category matrix comprises a plurality of elements, wherein one or more first elements of the account category matrix comprise a number of actual payment transactions by a target user of the at least one group of users using an account identifier associated with an account of the target user in one or more first merchant categories of a plurality of merchant categories during a time interval, wherein a second element of the account category matrix comprises a number of predicted payment transactions by the target user using the account identifier associated with the account of the target user in a second merchant category of the plurality of merchant categories during the time interval, wherein the number of predicted payment transactions by the user is determined based on the number of actual payment transactions by the target user in the one or more first merchant categories during the time interval and one or more merchant category similarity scores of the plurality of merchant category similarity scores of the merchant category similarity matrix for the second merchant category; generate one or more recommendations of an offer associated with the second merchant category; and communicate the one or more recommendations of an offer associated with the second merchant category to an issuer system associated with an issuer institution that issued the account of the target user.

Further embodiments or aspects are set forth in the following numbered clauses:

Clause 1: A method for determining a merchant category alignment of an account comprising: receiving, with at least one processor, transaction data associated with a plurality of payment transactions involving a plurality of users; comparing, with at least one processor, at least one parameter associated with the transaction data for each user of the plurality of users; segmenting, with at least one processor, the plurality of users into at least one group of users based on a similarity of the at least one parameter between each user of the at least one group of users; generating, with at least one processor, a merchant category similarity matrix for the at least one group of users based on the transaction data for each user in the at least one group, the merchant category similarity matrix comprising a plurality of merchant category similarity scores for the at least one group of users in each merchant category of a plurality of merchant categories, wherein the merchant category similarity scores are based on a determination of how likely each user of the at least one group of users is to conduct a payment transaction in a merchant category of the plurality of merchant categories based on that user conducting a payment transaction in another merchant category of the plurality of merchant categories; generating, with at least one processor, an account category matrix based on the transaction data, wherein the account category matrix comprises a plurality of elements, wherein a plurality of first elements of the account category matrix comprises a number of actual payment transactions by a target user of the at least one group of users using an account identifier associated with an account of the target user in one or more first merchant categories of a plurality of merchant categories during a predetermined time interval, wherein a second element of the account category matrix comprises a number of predicted payment transactions by the target user using the account identifier associated with the account of the target user in a second merchant category of the plurality of merchant categories during the predetermined time interval, and wherein the number of predicted payment transactions is determined based on the number of actual payment transactions by the target user in the one or more first merchant categories, independent of the second merchant category, during the predetermined time interval and a plurality of merchant category similarity scores of the merchant category similarity matrix for the second merchant category, independent of a merchant similarity score corresponding to the second merchant category; generating, with at least one processor, one or more recommendations of an offer associated with the second merchant category; and communicating, with at least one processor, the one or more recommendations of an offer associated with the second merchant category to an issuer system.

Clause 2: The method of clause 1, wherein generating the one or more recommendations of an offer comprises: generating one or more recommendations of an offer based on the number of predicted payment transactions by the target user in the second merchant category satisfying a threshold value.

Clause 3: The method of clauses 1 or 2, wherein the account category matrix comprises a third merchant category and a fourth merchant category, and wherein generating the account category matrix comprises: determining a number of predicted payment transactions by the target user using the account identifier associated with the account of the target user in the third merchant category during the predetermined time interval; determining a number of predicted payment transactions by the target user using the account identifier associated with the account of the target user in the fourth merchant category during the predetermined time interval; and wherein generating the one or more recommendations of an offer comprises: generating one or more recommendations of an offer associated with the third merchant category based on the number of predicted payment transactions by the target user in the third merchant category being greater than the number of predicted payment transactions by the target user in the fourth merchant category.

Clause 4: The method of any of clauses 1-3, wherein the account identifier associated with the account of the target user is a first account identifier associated with a first account of the target user, and wherein the account category matrix comprises one or more third elements, wherein the one or more third elements comprise a number of actual payment transactions by the target user using a second account identifier associated with a second account of the target user in one or more third merchant categories during the predetermined time interval.

Clause 5: The method of any of clauses 1-4, wherein the one or more third elements of the account category matrix comprise a number of predicted payment transactions by the target user using the second account identifier associated with the second account of the target user in one or more fourth merchant categories during the predetermined time interval.

Clause 6: The method of any of clauses 1-5, further comprising: generating one or more recommendations of an offer associated with the one or more fourth merchant categories; and communicating the one or more recommendations of an offer associated with the one or more fourth merchant categories to the target user.

Clause 7: The method of any of clauses 1-6, further comprising: determining the number of predicted payment transactions by the target user using the account identifier associated with the account of the target user in the second merchant category, wherein determining the number of predicted payment transactions comprises: multiplying each of the number of actual payment transactions by the target user using the account identifier associated with the account of the target user in the one or more first merchant categories during the predetermined time interval, independent of the number of actual payment transactions by the target user using the account identifier associated with the account of the target user in the second merchant category, by each merchant category similarity score for the second merchant category in the merchant category similarity matrix, independent of the merchant category similarity score corresponding to the second merchant category, to produce a set of products; adding each of the set of products to produce a weighted average of actual payment transactions; and dividing the weighted average of actual payment transactions by a sum of merchant category similarity scores of the merchant category similarity matrix for the second merchant category, independent of a merchant category similarity score corresponding to the second merchant category to produce the number of predicted payment transactions.

Clause 8: The method of any of clauses 1-7, wherein generating the merchant category similarity matrix comprises: generating the merchant category similarity matrix based on the equation:

$$sim ( a , b ) = cos ( a , b ) = \frac{\vec{a} \cdot \vec{b}}{‖ \vec{a} ‖ * ‖ \vec{b} ‖}$$

wherein the function “sim (a, b)” represents a similarity between a variable “a” and a variable “b”; wherein the variable “a” represents a vector that includes a plurality of first payment transaction scores, wherein each first payment transaction score comprises a number of actual payment transactions by a user of the at least one group of users using an account identifier associated with an account of the user in a first payment transaction merchant category of a plurality of payment transaction merchant categories during the predetermined time interval; wherein the variable “b” represents a vector that includes a plurality of second payment transaction scores, wherein each second payment transaction score comprises a number of actual payment transactions by a user of the at least one group of users using an account identifier associated with an account of the user in a second payment transaction merchant category of the plurality of payment transaction merchant categories during the predetermined time interval; wherein the similarity between the variable “a” and the variable “b” is calculated by calculating a cosine function of the variable “a” and the variable “b”; and wherein the plurality of payment transaction merchant categories comprises the plurality of merchant categories.

Clause 9: The method of any of clauses 1-8, wherein the at least one parameter comprises at least one of the following: a parameter associated with an affluence score of a user; a parameter associated with an age group of a user; a parameter associated with foreign and domestic travel conducted by a user; a parameter associated with online engagement of a user; a parameter associated with a geographic location of a user; a parameter associated with a time interval between an account enrollment date and a date of a payment transaction that is a most recent payment transaction involving a user; a parameter associated with a number of merchant category codes that are active for a user; or any combination thereof.

Clause 10: The method of any of clauses 1-9, wherein the at least one parameter comprises a distance of a residence location of each user of the at least one group of users from a predetermined zip code.

Clause 11: A system for determining a merchant category alignment of an account, the system comprising: at least one processor programmed or configured to: receive transaction data associated with a plurality of payment transactions involving a plurality of users and a plurality of merchants in a plurality of merchant categories; determine at least one parameter associated with the transaction data for each user of the plurality of users; determine at least one group of users of the plurality users based on determining the at least one parameter; generate a merchant category similarity matrix for the at least one group of users based on the transaction data for each user in the at least one group, the merchant category similarity matrix comprising a plurality of merchant category similarity scores for the at least one group of users in each merchant category of the plurality of merchant categories, wherein the merchant category similarity scores are based on a determination of how likely each user of the at least one group of users is to conduct a payment transaction in a merchant category of the plurality of merchant categories based on that user conducting a payment transaction in another merchant category of the plurality of merchant categories; generate an account category matrix based on the transaction data and the merchant category similarity matrix, wherein the account category matrix comprises a plurality of elements, wherein a plurality of first elements of the account category matrix comprises a number of actual payment transactions by a target user of the at least one group of users using an account of the target user in one or more first merchant categories of the plurality of merchant categories during a predetermined time interval, wherein a second element of the account category matrix comprises a number of predicted payment transactions by the target user using the account of the target user in a second merchant category of the plurality of merchant categories during the predetermined time interval, wherein the number of predicted payment transactions is determined based on the number of actual payment transactions by the target user in the one or more first merchant categories during the predetermined time interval and the plurality of merchant category similarity scores of the merchant category similarity matrix for the second merchant category; generate one or more recommendations of an offer associated with the second merchant category based on generating the account category matrix; and communicate the one or more recommendations of an offer associated with the second merchant category to an issuer system associated with an issuer institution that issued the account of the target user.

Clause 12: The system of clause 11, wherein the at least one processor is further programmed or configured to: determine the number of predicted payment transactions by the target user using the account of the target user in the second merchant category, wherein the at least one processor, when determining the number of predicted payment transactions, is programmed or configured to: multiply each of the number of actual payment transactions by the target user using the account of the target user in the one or more first merchant categories during the predetermined time interval, independent of the number of actual payment transactions by the target user using the account of the target user in the second merchant category, by each merchant category similarity score for the second merchant category in the merchant category similarity matrix, independent of a merchant category similarity score corresponding to the second merchant category, to produce a set of products; add each of the set of products to produce a weighted average of actual payment transactions; and divide the weighted average of actual payment transactions by a sum of merchant category similarity scores of the merchant category similarity matrix for the second merchant category, independent of a merchant category similarity score corresponding to the second merchant category to produce the number of predicted payment transactions.

Clause 13: The system of clauses 11 or 12, wherein the at least one processor, when generating the one or more recommendations of an offer, is programmed or configured to: generate one or more recommendations of an offer based on the number of predicted payment transactions by the target user in the second merchant category satisfying a threshold value of a number of predicted payment transactions.

Clause 14: The system of any of clauses 11-13, wherein the account category matrix comprises one or more third elements, wherein the one or more third elements comprise a second number of actual payment transactions by the target user using a second account of the target user in one or more third merchant categories during the predetermined time interval.

Clause 15: The system of any of clauses 11-14, wherein the one or more third elements of the account category matrix comprise a number of predicted payment transactions by the target user using the second account of the target user in a fourth merchant category during the predetermined time interval.

Clause 16: The system of any of clauses 11-15, wherein the at least one processor is further programmed or configured to: generate one or more recommendations of an offer associated with the fourth merchant category; and communicate the one or more recommendations of an offer associated with the fourth merchant category to the target user.

Clause 17: A computer program product for determining a merchant category alignment of an account, the computer program product comprising at least one non-transitory computer-readable medium including one or more instructions that, when executed by at least one processor, cause the at least one processor to: determine at least one parameter associated with transaction data, wherein the transaction data is associated with a plurality of payment transactions involving a plurality of users, wherein determining the at least one parameter comprises determining a value of the at least one parameter for each user of the plurality of users; determine at least one group of users of the plurality users based on the at least one parameter; generate a merchant category similarity matrix for the at least one group of users based on the transaction data for each user in the at least one group, the merchant category similarity matrix comprising a plurality of merchant category similarity scores for the at least one group of users in each merchant category of a plurality of merchant categories, wherein the merchant category similarity scores are based on a determination of how likely each user of the at least one group of users is to conduct a payment transaction in a merchant category of the plurality of merchant categories based on that user conducting a payment transaction in another merchant category of the plurality of merchant categories; generate an account category matrix based on the transaction data, wherein the account category matrix comprises a plurality of elements, wherein one or more first elements of the account category matrix comprise a number of actual payment transactions by a target user of the at least one group of users using an account identifier associated with an account of the target user in one or more first merchant categories of a plurality of merchant categories during a time interval, wherein a second element of the account category matrix comprises a number of predicted payment transactions by the target user using the account identifier associated with the account of the target user in a second merchant category of the plurality of merchant categories during the time interval, wherein the number of predicted payment transactions by the user is determined based on the number of actual payment transactions by the target user in the one or more first merchant categories during the time interval and one or more merchant category similarity scores of the plurality of merchant category similarity scores of the merchant category similarity matrix for the second merchant category; generate one or more recommendations of an offer associated with the second merchant category; and communicate the one or more recommendations of an offer associated with the second merchant category to an issuer system associated with an issuer institution that issued the account of the target user.

Clause 18: The computer program product of clause 17, wherein the at least one parameter comprises at least one of the following: a parameter associated with an affluence score of a user; a parameter associated with an age group of a user; a parameter associated with foreign and domestic travel conducted by a user; a parameter associated with online engagement of a user; a parameter associated with a geographic location of a user; a parameter associated with a time interval between an account enrollment date and a date of a payment transaction that is a most recent payment transaction involving a user; a parameter associated with a number of merchant category codes that are active for a user; or any combination thereof.

Clause 19: The computer program product of clauses 17 or 18, wherein the at least one parameter comprises a distance of a residence location of each user of the at least one group of users from a predetermined zip code.

Clause 20: The computer program product of any of clauses 17-19, wherein the one or more instructions further cause the at least one processor to: determine the number of predicted payment transactions by the target user using the account identifier associated with the account of the target user in the second merchant category.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a diagram of a non-limiting embodiment of an environment in which systems, devices, products, apparatus, and/or methods, described herein, may be implemented according to the principles of the present invention;

FIG. 2 is a diagram of a non-limiting embodiment of components of one or more devices of FIG. 1;

FIG. 3 is a flowchart of a non-limiting embodiment of a process for determining a merchant category alignment of an account; and

FIGS. 4A-4E are diagrams of an implementation of a non-limiting embodiment of the process shown in FIG. 3.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet and/or the like) that includes data. It will be appreciated that numerous other arrangements are possible. It will be appreciated that numerous other arrangements are possible.

As used herein, the terms “issuer institution,” “portable financial device issuer,” “issuer,” or “issuer bank” may refer to one or more entities that provide one or more accounts to a user (e.g., customer, consumer, and/or the like) for conducting transactions (e.g., payment transactions), such as initiating credit card payment transactions and/or debit card payment transactions. For example, an issuer institution may provide an account identifier, such as a personal account number (PAN), to a user that uniquely identifies one or more accounts associated with that user. The account identifier may be embodied on a portable financial device, such as a physical financial instrument (e.g., a payment card), and/or may be electronic and used for electronic payments. In some non-limiting embodiments, an issuer institution may be associated with a bank identification number (BIN) that uniquely identifies the issuer institution. As used herein “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “account identifier” may refer to one or more types of identifiers associated with a user account (e.g., an account identifier, a PAN, a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payment transactions. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of identifier. Account identifiers may be alphanumeric, any combination of characters and/or symbols, and/or the like.

As used herein, the term “token” may refer to an identifier that is used as a substitute or replacement identifier for an account identifier, such as a PAN. A token may be used as a substitute or replacement identifier for an original account identifier, such as a PAN. Tokens may be associated with a PAN or other original account identifier in one or more data structures (e.g., one or more databases and/or the like) such that they may be used to conduct a transaction without directly using the original account identifier. In some non-limiting embodiments, an original account identifier, such as a PAN, may be associated with a plurality of tokens for different individuals or purposes. In some non-limiting embodiments, tokens may be associated with a PAN or other account identifiers in one or more data structures such that they can be used to conduct a transaction without directly using the account identifier, such as a PAN. In some examples, an account identifier, such as a PAN, may be associated with a plurality of tokens for different uses or different purposes.

As used herein, the term “merchant” may refer to one or more entities (e.g., operators of retail businesses) that provide goods and/or services, and/or access to goods and/or services, to a user based on a transaction, such as a payment transaction. As used herein “merchant system” may refer to one or more computer systems operated by or on behalf of a merchant, such as a server executing one or more software applications. As used herein, the term “product” may refer to one or more goods and/or services offered by a merchant.

As used herein, a “point-of-sale (POS) device” may refer to one or more devices, which may be used by a merchant to conduct a transaction (e.g., a payment transaction) and/or process a transaction. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, a “POS system” may refer to one or more computers and/or peripheral devices used by a merchant to conduct a transaction. For example, a POS system may include one or more POS devices, and/or other like devices that may be used to conduct a payment transaction. A POS system (e.g., a merchant POS system) may also include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network, such as Visa®, MasterCard®, American Express®, or any other entity that processes transactions. As used herein “transaction service provider system” may refer to one or more computer systems operated by or on behalf of a transaction service provider, such as a transaction service provider system executing one or more software applications. A transaction service provider system may include one or more processors and, in some non-limiting embodiments, may be operated by or on behalf of a transaction service provider.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet application, a personal digital assistant (PDA), a pager, a security card, a computer, an access card, a wireless terminal, and/or a transponder, as examples. The portable financial device may include volatile or non-volatile memory to store information (e.g., an account identifier, a name of the account holder, and/or the like).

As used herein, the terms “client” and “client device” may refer to one or more client-side devices or systems, remote from a transaction service provider, used to initiate or facilitate a transaction. As an example, a “client device” may refer to one or more POS devices and/or POS systems used by a merchant. It will be appreciated that a client device may be any electronic device configured to communicate with one or more networks and initiate or facilitate transactions such as, but not limited to, one or more computers, portable computers, tablet computers, cellular phones, wearable devices (e.g., watches, glasses, lenses, clothing, and/or the like), PDAs, and/or other like devices. Moreover, a “client” may also refer to an entity, such as a merchant, that owns, utilizes, and/or operates a client device for initiating transactions with a transaction service provider.

As used herein, the term “server” may refer to one or more computing devices, such as processors, storage devices, and/or similar computer components that communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments of the present invention are directed to systems, methods, and computer program products for determining a category alignment of an account. In some non-limiting embodiments, a method may include receiving transaction data associated with a plurality of payment transactions involving a plurality of users, generating a merchant category similarity matrix for a group of users based on the transaction data for each user in the group, where the merchant category similarity matrix may include a plurality of merchant category similarity scores for each user in each merchant category of a plurality of merchant categories. In some non-limiting embodiments, the merchant category similarity scores may be based on a determination of how likely each user of the at least one group of users is to conduct a payment transaction in a second merchant category of the plurality of merchant categories based on that user conducting a payment transaction in a first merchant category of the plurality of merchant categories.

In some non-limiting embodiments, the method may further include generating an account category matrix based on the transaction data and/or the merchant category similarity matrix, where the account category matrix may include a plurality of elements and where one or more first elements of the account category matrix may include a number of actual payment transactions by a user of the group of users using an account identifier associated with an account of the user in one or more first merchant categories of a plurality of merchant categories during a predetermined time interval. In some non-limiting embodiments, one or more second elements of the account category matrix may include a number of predicted payment transactions by the user using the account identifier associated with the account of the user in one or more second merchant categories of the plurality of merchant categories during the predetermined time interval. In some non-limiting embodiments, the number of predicted payment transactions may be determined based on the number of actual payment transactions by the user in the one or more first merchant categories during the predetermined time interval and one or more merchant category similarity scores of the plurality of merchant category similarity scores of the merchant category similarity matrix for the one or more second merchant categories, independent of a merchant category similarity score corresponding to the one or more second merchant categories.

In some non-limiting embodiments, the method may further include generating one or more recommendations of an offer associated with the one or more second merchant categories and communicating the one or more recommendations of an offer associated with the one or more second merchant categories to the user.

In this way, embodiments of the present are effective at accurately determining a merchant category in which a user is likely to conduct a payment transaction using an account associated with the user. Accordingly, a financial institution that issued the account associated with the user may communicate an offer to the user that is effective at encouraging the user to conduct a payment transaction with a merchant in the merchant category. For example, an offer may be communicated to the one or more users based on a determination that the user is likely to conduct a payment transaction in a particular merchant category during a predetermined time interval. In this way, embodiments of the present invention may reduce consumption of network resources and processing resources associated with communicating one or more offers to the user based on a determination that a user is likely to conduct a payment transaction in a merchant category as compared to communicating one or more offers to the one or more users independent of the determination.

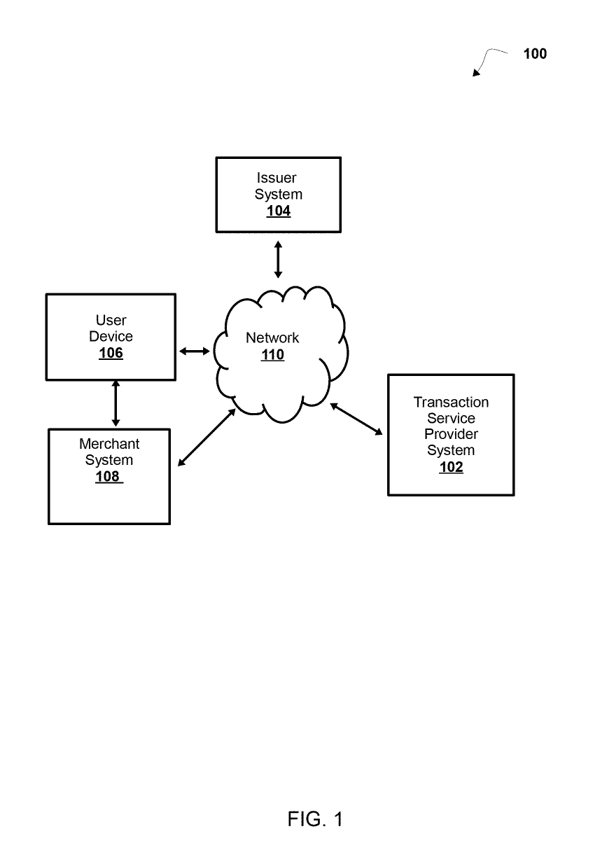

Referring now to FIG. 1, FIG. 1 is a diagram of an example environment 100 in which devices, systems, and/or methods, described herein, may be implemented. As shown in FIG. 1, environment 100 includes a transaction service provider system 102, an issuer system 104, a user device 106, a merchant system 108, and a network 110. Transaction service provider system 102, issuer system 104, user device 106, and/or merchant system 108 may interconnect (e.g., establish a connection to communicate) via wired connections, wireless connections, or a combination of wired and wireless connections.

Transaction service provider system 102 may include one or more devices capable of receiving information from issuer system 104, user device 106, and/or merchant system 108 via network 110 and/or communicating information to issuer system 104, user device 106, and/or merchant system 108 via network 110. For example, transaction service provider system 102 may include a computing device, such as a server (e.g., a transaction processing server), a group of servers, and/or other like devices. In some non-limiting embodiments, transaction service provider system 102 may be associated with a transaction service provider as described herein. In some non-limiting embodiments, transaction service provider system 102 may be in communication with a data storage device, which may be local or remote to the transaction service provider system 102. In some non-limiting embodiments, transaction service provider system 102 may be capable of receiving information from, storing information in, communicating information to, or searching information stored in data storage device.

Issuer system 104 may include one or more devices capable of receiving information from transaction service provider system 102 and/or user device 106 via a network (e.g., network 110) and/or communicating information to transaction service provider system 102, user device 106, and/or merchant system 108 via the network. For example, issuer system 104 may include a computing device, such as a server, a group of servers, and/or other like devices. In some non-limiting embodiments, issuer system 104 may be associated with an issuer institution as described herein. For example, issuer system 104 may be associated with an issuer institution that issued a credit account, debit account, credit card, debit card, and/or the like to a user associated with user device 106.

User device 106 may include one or more devices capable of receiving information from and/or communicating information to transaction service provider system 102, issuer system 104, and/or merchant system 108, via network 110. For example, user device 106 may include a client device and/or the like. In some non-limiting embodiments, user device 106 may or may not be capable of receiving information (e.g., from merchant system 108) via a short range wireless communication connection (e.g., an NFC communication connection, an RFID communication connection, a Bluetooth® communication connection, and/or the like), and/or communicating information (e.g., to merchant system 108) via a short range wireless communication connection.

Merchant system 108 may include one or more devices capable of receiving information from transaction service provider system 102, issuer system 104, and/or user device 106 via network 110 and/or communicating information to transaction service provider system 102, issuer system 104, and/or user device 106 via network 110. Merchant system 108 may also include a device capable of receiving information from user device 106 via network 110, a communication connection (e.g., an NFC communication connection, an RFID communication connection, a Bluetooth® communication connection, and/or the like) with user device 106, and/or the like, and/or communicating information to user device 106 via the network, the communication connection, and/or the like. For example, merchant system 108 may include a computing device, such as a server, a group of servers, a client device, a group of client devices, and/or other like devices. In some non-limiting embodiments, merchant system 108 may be associated with a merchant as described herein. In some non-limiting embodiments, merchant system 108 may include one or more user devices 106. For example, merchant system 108 may include user device 106 that allows a merchant to communicate information to transaction service provider system 102. In some non-limiting embodiments, merchant system 108 may include one or more devices, such as computers, computer systems, and/or peripheral devices capable of being used by a merchant to conduct a payment transaction with a user. For example, merchant system 108 may include a POS device and/or a POS system.

Network 110 may include one or more wired and/or wireless networks. For example, network 110 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

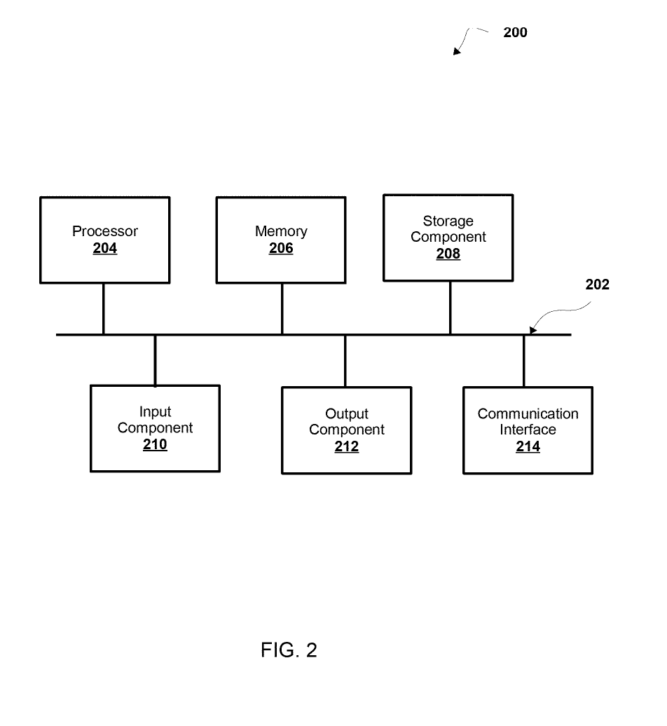

Referring now to FIG. 2, FIG. 2 is a diagram of example components of a device 200. Device 200 may correspond to transaction service provider system 102, and/or one or more devices of issuer system 104, user device 106, and/or merchant system 108. In some non-limiting embodiments, transaction service provider system 102, issuer system 104, user device 106, and/or merchant system 108 may include at least one device 200 and/or at least one component of device 200. As shown in FIG. 2, device 200 may include a bus 202, a processor 204, memory 206, a storage component 208, an input component 210, an output component 212, and a communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

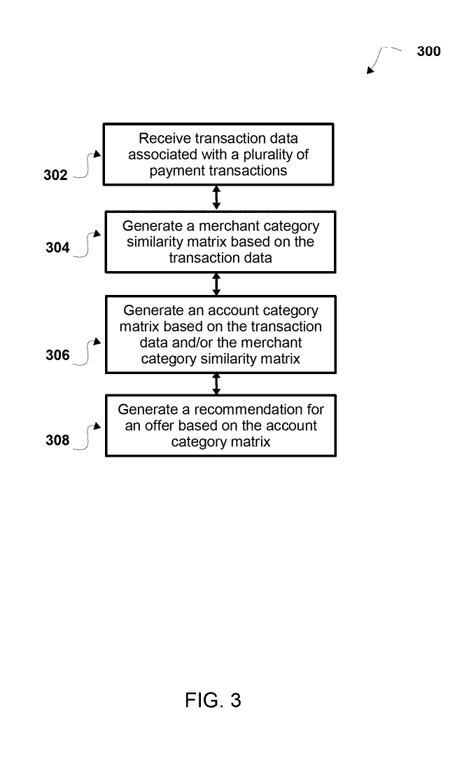

Referring now to FIG. 3, FIG. 3 is a flowchart of a non-limiting embodiment of a process 300 for determining a merchant category alignment of an account. In some non-limiting embodiments, one or more of the steps of process 300 may be performed (e.g., completely, partially, etc.) by transaction service provider system 102 (e.g., one or more devices of transaction service provider system 102). In some non-limiting embodiments, one or more of the steps of process 300 may be performed (e.g., completely, partially, etc.) by another device or a group of devices separate from or including transaction service provider system 102, such as issuer system 104 (e.g., one or more devices of issuer system 104), user device 106, or merchant system 108 (e.g., one or more devices of merchant system 108).

As shown in FIG. 3, at step 302, process 300 includes receiving transaction data associated with a plurality of payment transactions. For example, transaction service provider system 102 may receive transaction data (e.g., historical transaction data, first transaction data, first historical transaction data, and/or the like) associated with a plurality of payment transactions involving (e.g., conducted by) a user, a plurality of users, and/or the like. In some non-limiting embodiments, the transaction data may be associated with a plurality of payment transactions involving one or more accounts (e.g., a credit card account, a debit card account, and/or the like) associated with a user, a plurality of accounts of a plurality of users, and/or the like.

In some non-limiting embodiments, transaction service provider system 102 may receive the transaction data from issuer system 104 and/or merchant system 108 (e.g., via network 110). For example, transaction service provider system 102 may receive the transaction data from merchant system 108 via network 110 in real-time while a payment transaction is being conducted, after a payment transaction has been authorized, after a payment transaction has been cleared, and/or after a payment transaction has been settled. In some non-limiting embodiments, historical transaction data may include transaction data associated with one or more payment transactions that have been authorized, cleared, and/or settled.

In some non-limiting embodiments, the transaction data may be associated with a payment transaction (e.g., a payment transaction of a plurality of payment transactions) and/or a plurality of payment transactions. For example, the transaction data may be associated with a payment transaction involving a user and a merchant (e.g., a merchant associated with merchant system 108). In some non-limiting embodiments, the plurality of payment transactions may involve a plurality of users and a plurality of merchants and each payment transaction of the plurality of payment transactions may involve a single user and a single merchant.

In some non-limiting embodiments, the transaction data associated with a payment transaction may include transaction amount data associated with an amount of the payment transaction (e.g., a cost associated with the payment transaction, a transaction amount, an overall transaction amount, a cost of one or more products involved in the payment transaction, and/or the like), transaction time data associated with a time interval at which the payment transaction occurred (e.g., a time of day, a day of the week, a day of a month, a month of a year, a predetermined time of day segment such as morning, afternoon, evening, night, and/or the like, a predetermined day of the week segment such as weekday, weekend, and/or the like, a predetermined segment of a year such as first quarter, second quarter, and/or the like), transaction type data associated with a transaction type of the payment transaction (e.g., an online transaction, a card present transaction, a face-to-face transaction, and/or the like), and/or the like.

Additionally or alternatively, the transaction data may include user transaction data associated with the user involved in the payment transaction, merchant transaction data associated with the merchant involved in the payment transaction, and/or issuer institution transaction data associated with an issuer institution of an account involved in the payment transaction. In some embodiments, user transaction data may include user identity data associated with an identity of the user (e.g., a unique identifier of the user, a name of the user, and/or the like), user account data associated with an account of the user (e.g., an account identifier associated with the user, a PAN associated with a credit and/or debit account of the user, a token associated with a credit and/or debit account of the user, and/or the like), and/or the like.

In some embodiments, merchant transaction data may include merchant identity data associated with an identity of the merchant (e.g., a unique identifier of the merchant, a name of the merchant, and/or the like), merchant category data associated with at least one merchant category of the merchant (e.g., a code for a merchant category, a name of a merchant category, a type of a merchant category, and/or the like), merchant account data associated with an account of the merchant (e.g., an account identifier associated with an account of the merchant, a PAN associated with an account of the merchant, a token associated with an account of the merchant, and/or the like), and/or the like.

In some embodiments, issuer institution transaction data may include issuer institution identity data associated with the issuer institution that issued an account involved in the payment transaction (e.g., a unique identifier of the issuer institution, a name of the issuer institution, an issuer identification number (IIN) associated with the issuer institution, a BIN associated with the issuer institution, and/or the like), and/or the like.

In some non-limiting embodiments, transaction data associated with a payment transaction (e.g., each payment transaction of a plurality of payment transactions) may identify a merchant category of a merchant involved in the payment transaction. For example, transaction data associated with the payment transaction may include merchant transaction data that identifies a merchant category of a merchant involved in the payment transaction. A merchant category may be information that is used to classify the merchant based on the type of goods or services the merchant provides. In some non-limiting embodiments, a payment transaction may involve a merchant that is associated with a merchant category of a plurality of merchant categories.

In some non-limiting embodiments, transaction data associated with a payment transaction may identify a time (e.g., a time of day, a day, a week, a month, a year, a predetermined time interval, and/or the like) at which the payment transaction occurred. For example, the transaction data associated with the payment transaction may include transaction time data that identifies a time interval at which the payment transaction occurred.

In some non-limiting embodiments, transaction service provider system 102 may determine a parameter associated with the transaction data for a user of a plurality of users, each user of a plurality of users, or a group of users of a plurality of users. For example, transaction service provider system 102 may determine a parameter associated with the transaction data for each user of a plurality of users so that transaction service provider system 102 may determine a group of users of the plurality of users based on the parameter. In some non-limiting embodiments, the parameter may be associated with a spending behavior of a user (e.g., a spending behavior associated with an account of a user). For example, the parameter may be associated with an affluence score of a user (e.g., the parameter may be associated with an average transaction amount of a plurality of payment transactions involving a user, a maximum transaction amount of a plurality of payment transactions involving a user, a minimum transaction amount of a plurality of payment transactions involving a user, and/or the like), a location of a user (e.g., the parameter may be associated with a residential location of a user, a geographic location of a user, a merchant location of a merchant involved in a number of payment transactions with a user, a number of payment transactions involving a user and a merchant, where the merchant is a predetermined distance from a residential location of the user, and/or the like), an online engagement (e.g., online savviness) of a user (e.g., the parameter may be associated with a percentage of payment transactions involving a user that are online payment transactions, whether a user account of the user is accessed by the user a threshold number of times using an online access method, and/or the like), a travel behavior of a user (e.g., the parameter associated with foreign and domestic travel conducted by a user), a demographic of a user (e.g., the parameter may be associated with an age group of a user), an account tenure of a user (e.g., a parameter associated with a time interval between an account enrollment date and a date of a payment transaction that is the most recent payment transaction involving a user), a number of active merchant category codes (e.g., a parameter associated with a number of merchant category codes that are active for a user, a number of merchant category codes in which a payment transaction has been conducted involving a user during a time interval, and/or the like), and/or the like.

In some non-limiting embodiments, transaction service provider system 102 may determine a value of the parameter for each user of a plurality of users. For example, transaction service provider system 102 may determine the value of the parameter for each user of a plurality of users based on transaction data associated with a plurality of payment transactions involving accounts of the plurality of users. In another example, the at least one parameter where the value of the parameter includes a distance from a residence (e.g., a house, a living place, and/or the like) of each user of the plurality of users to a location (e.g., a geographic location, a geographic area, a zip code, a predetermined zip code, and/or the like). In some non-limiting embodiments, transaction service provider system 102 may compare the value of the parameter for each user of a plurality of users. For example, transaction service provider system 102 may compare a first value of the parameter for a first user of the plurality of users to a second value of the parameter for a second user of the plurality of users.

In some non-limiting embodiments, transaction service provider system 102 may determine whether the value of the parameter corresponds for each user of a plurality of users. For example, transaction service provider system 102 may determine whether a first value of the parameter for a first user of the plurality of users is the same as a second value of the parameter for a second user of the plurality of users. In some non-limiting embodiments, transaction service provider system 102 may determine whether the value of the parameter corresponds for each user of a plurality of users based on whether a difference between the value of the parameter for a first user of the plurality of users and the value of the parameter for a second user of the plurality of users satisfies a threshold. For example, transaction service provider system 102 may determine whether a difference between a first value of the parameter for a first user of the plurality of users and a second value of the parameter for a second user of the plurality of users satisfies a threshold value of the difference (e.g., a maximum threshold value of the difference, a minimum threshold value of the difference, and/or the like).

In some non-limiting embodiments, transaction service provider system 102 may determine a group for each user of the plurality of users based on the value of the parameter. For example, transaction service provider system 102 may determine a group for a set of users of the plurality of users based on determining that the value of the parameter corresponds for each user of the set of users.

In some non-limiting embodiments, transaction service provider system 102 may segment the plurality of users into one or more groups of users based on a similarity of the parameter between each user of the one or more groups of users. For example, transaction service provider system 102 may determine a value of the parameter for each user of a plurality of users. Transaction service provider system 102 may compare the value of the parameter for each user to the value of the parameter for one or more other users of the plurality of users. Transaction service provider system 102 may determine a similarity of the parameter (e.g., a similarity of the value of the parameter for each user as compared to the value of the parameter for one or more other users of the plurality of users) between each user of the plurality of users based on comparing the value of the parameter. Transaction service provider system 102 may segment the plurality of users in the one or more groups based on determining the similarity of the parameter between each user of the plurality of users. In some non-limiting embodiments, the similarity of the parameter may include a threshold value of a difference of the value of the parameter for a first user and the value of the parameter for a second user.

As further shown in FIG. 3, at step 304, process 300 includes generating a merchant category similarity matrix based on the transaction data. For example, transaction service provider system 102 may generate a merchant category similarity matrix based on the transaction data associated with a plurality of payment transactions involving a user, a plurality of users, and/or the like. In some non-limiting embodiments, transaction service provider system 102 may generate a merchant category similarity matrix for a group of users based on the transaction data for each user in the group. In some non-limiting embodiments, the merchant category similarity matrix may include an identifier of a merchant category (e.g., a merchant category identifier, a MCC, and/or the like) on a first axis and an identifier of merchant category on a second axis.

In some non-limiting embodiments, the merchant category similarity matrix may include a plurality of merchant category similarity scores for each user in each merchant category of a plurality of merchant categories (e.g., a plurality of merchant categories associated with a plurality of MCCs). In some non-limiting embodiments, the merchant category similarity scores may be based on a determination of how likely each user of the group of users is to conduct a payment transaction in a second merchant category of the plurality of merchant categories based on that user conducting a payment transaction in a first merchant category of the plurality of merchant categories.

In some non-limiting embodiments, transaction service provider system 102 may generate the merchant category similarity matrix based on the equation:

$$sim ( a , b ) = cos ( a , b ) = \frac{\vec{a} \cdot \vec{b}}{‖ \vec{a} ‖ * ‖ \vec{b} ‖}$$

The function “sim (a, b)” may represent a similarity between the variable “a” and the variable “b”. The variable “a” may represent a vector that includes a plurality of first payment transaction scores, where each first payment transaction score includes a number of actual payment transactions by a user of a group of users using an account of the user (e.g., using an account identifier associated with an account of the user) in a first merchant category (e.g., a first payment transaction merchant category) of a plurality of merchant categories (e.g., a plurality of payment transaction merchant categories) during a time interval (e.g., a predetermined time interval). The variable “b” may represent a vector that includes a plurality of second payment transaction scores, where each second payment transaction score includes a number of actual payment transactions by a user of the group of users using an account of the user in a second merchant category (e.g., a second payment transaction merchant category) of the plurality of merchant categories during the time interval. The similarity between the variable “a” and the variable “b” may be calculated by calculating a cosine function of the variable “a” and the variable “b.”

As further shown in FIG. 3, at step 306, process 300 includes generating an account category matrix based on the transaction data and/or the merchant category similarity matrix. For example, transaction service provider system 102 may generate an account category matrix based on the transaction data and/or the merchant category similarity matrix.

In some non-limiting embodiments, transaction service provider system 102 may generate the account category matrix based on the transaction data and/or the merchant category similarity matrix, where the account category matrix may include a plurality of elements. In some non-limiting embodiments, the account category matrix may include an account identifier of an account (e.g., an account identifier of a credit card account, an account identifier of a debit card account, a PAN of an account, and/or the like) on a first axis and an identifier of a merchant category (e.g., a merchant category identifier, a MCC, and/or the like) on a second axis. One or more first elements of the account category matrix may include a number of payment transactions (e.g., a number of actual payment transactions) conducted by a user (e.g., a target user, a user different from a target user, and/or the like) of a group of users using an account of the user (e.g., using an account identifier associated with an account of the user) in one or more first merchant categories of a plurality of merchant categories during a time interval (e.g., a predetermined time interval). One or more second elements of the account category matrix may include a number of payment transactions to be conducted by the user (e.g., a number of predicted payment transactions by the user) using the account of the user in one or more second merchant categories of the plurality of merchant categories during the time interval.

In some non-limiting embodiments, the account category matrix may include one or more third elements. For example, the account category matrix may include one or more third elements that include a number of actual payment transactions by a user using a second account (e.g., using a second account identifier associated with a second account) of the user in one or more merchant categories (e.g., one or more third merchant categories) during a time interval. In some non-limiting embodiments, the second account may be different than an account of the user used to conduct a number of payment transactions in the one or more first merchant categories and/or the one or more second merchant categories of the plurality of merchant categories.

In some non-limiting embodiments, transaction service provider system 102 may determine a number of payment transactions to be conducted by a user (e.g., a number of predicted payment transactions by a user) based on a number of payment transactions conducted by the user (e.g., a number of actual payment transactions by the user) in the one or more first merchant categories during a time interval (e.g., a predetermined time interval) and one or more merchant category similarity scores of the plurality of merchant category similarity scores of the merchant category similarity matrix for the one or more second merchant categories, independent of a merchant similarity score corresponding to the one or more second merchant categories.

In some non-limiting embodiments, the one or more second merchant categories may include a third merchant category and a fourth merchant category. In some non-limiting embodiments, transaction service provider system 102 may determine a number of predicted payment transactions by the user using the account of the user in the third merchant category during a time interval. Additionally or alternatively, transaction service provider system 102 may determine a number of predicted payment transactions by the user using the account of the user in the fourth merchant category during the time interval.

In some non-limiting embodiments, transaction service provider system 102 may determine a number of payment transactions to be conducted by a user using the account of the user in one or more second merchant categories based on a number of payment transactions conducted by the user (e.g., a number of actual payment transactions by the user) using the account of the user in one or more first merchant categories. For example, transaction service provider system 102 may multiply each of a number of payment transactions conducted by the user using the account of the user (e.g., the account identifier associated with the account of the user) in the one or more first merchant categories during a time interval, independent of the number of actual payment transactions by the target user using the account of the target user in the one or more second merchant categories, by each merchant category similarity score for the second merchant category in the merchant category similarity matrix (e.g., each merchant category similarity score for the second merchant category in the merchant category similarity matrix independent of a merchant category similarity score corresponding to the second merchant category) to produce a set of products.

In some non-limiting embodiments, transaction service provider system 102 may add each product of the set of products together to produce a weighted average of actual payment transactions. In some non-limiting embodiments, transaction service provider system 102 may divide the weighted average of actual payment transactions by a sum of one or more (e.g., one, a plurality, all, and/or the like) merchant category similarity scores of the merchant category similarity matrix for the one or more second merchant categories, independent of a merchant category similarity score corresponding to the one or more second merchant categories. In some non-limiting embodiments, the result of dividing the weighted average of actual payment transactions by the sum of the one or more merchant category similarity scores of the merchant category similarity matrix for the one or more second merchant categories may produce the number of payment transactions to be conducted by the user.

As further shown in FIG. 3, at step 308, process 300 includes generating a recommendation for an offer based on the account category matrix. For example, transaction service provider system 102 may generate a recommendation for an offer (e.g., a recommendation for an offer to a user, a recommendation for an offer to an account of a user, and/or the like) associated with one or more merchant categories based on the account category matrix. In some non-limiting embodiments, transaction service provider system 102 may generate a recommendation for an offer associated with one or more merchant categories for a user of a group of users based on an account category matrix associated with the group of users.

In some non-limiting embodiments, transaction service provider system 102 may generate a recommendation for an offer based on a number of payment transactions to be conducted (e.g., a number of predicted payment transactions) by a user using an account of the user in one or more merchant categories of a plurality of merchant categories. For example, transaction service provider system 102 may determine that the number of payment transactions to be conducted by the user in a first merchant category is greater than a number of payment transactions to be conducted by the user in a second merchant category. Transaction service provider system 102 may generate a recommendation for an offer associated with the first merchant category based on determining that the number of payment transactions to be conducted by the user in the first merchant category is greater than the number of payment transactions to be conducted by the user in the second merchant category.

In another example, transaction service provider system 102 may determine a merchant category associated with a maximum number of payment transactions to be conducted by the user using an account of the user by comparing each of the numbers of transactions to be conducted by the user using the account of the user in the one or more merchant categories of an account category matrix. Transaction service provider system 102 may generate a recommendation for an offer associated with the merchant category having the maximum number of payment transactions to be conducted by the user in the account category matrix.

In some non-limiting embodiments, transaction service provider system 102 may generate a recommendation for an offer associated with one or more merchant categories based on determining whether the number of payment transactions to be conducted by a user (e.g., a number of predicted payment transactions by a user, a maximum number of predicted payment transactions by a user, a minimum number of predicted payment transactions by a user, and/or the like) in the one or more merchant categories satisfies a threshold (e.g., a threshold value of a number of predicted payment transactions). For example, transaction service provider system 102 may generate a recommendation for an offer based on determining that the number of predicted payment transactions by the user in the one or more merchant categories satisfies a threshold value of a number of predicted payment transactions by the user (e.g., a maximum threshold value of a number of predicted payment transactions, a minimum threshold value of a number of predicted payment transactions, and/or the like). In such an example, transaction service provider system 102 may generate the recommendation for an offer associated with the one or more merchant categories determined to be associated with the number of predicted payment transactions by the user that satisfies the threshold value of the number of predicted payment transactions by the user.

In some non-limiting embodiments, transaction service provider system 102 may communicate a recommendation of an offer associated with one or more merchant categories based on generating the recommendation of an offer. For example, transaction service provider system 102 may communicate the recommendation of an offer to issuer system 104, user device 106, and/or merchant system 108 based on generating the recommendation of an offer. In some non-limiting embodiments, transaction service provider system 102 may communicate a recommendation of an offer associated with one or more merchant categories to an issuer system (e.g., issuer system 104) associated with an issuer institution that issued an account of a user. For example, transaction service provider system 102 may communicate the recommendation of an offer to the issuer system (e.g., issuer system 104) associated with the issuer institution that issued the account of the user, where the account of the user is an account to be used by the user to conduct a number of predicted payment transactions.

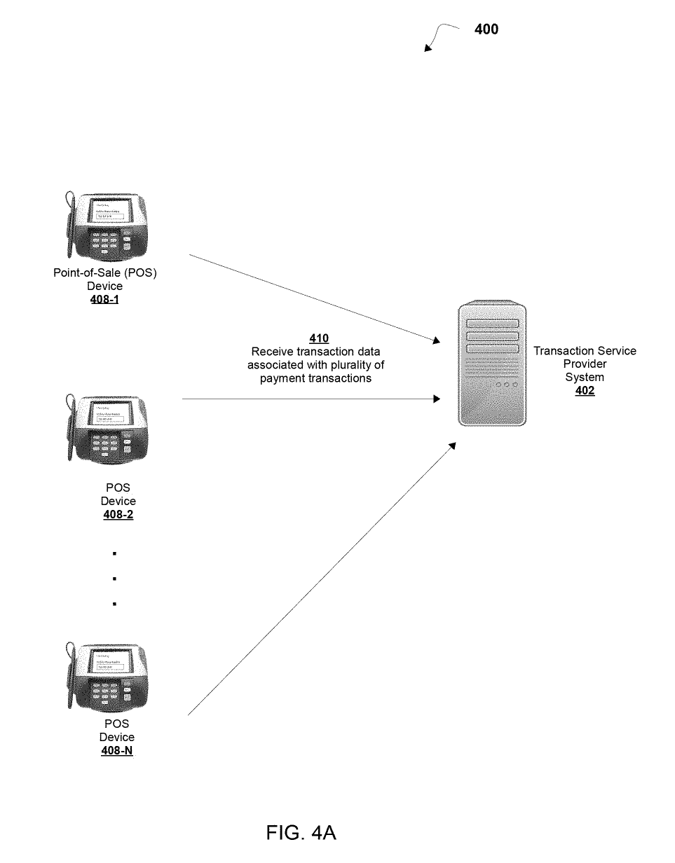

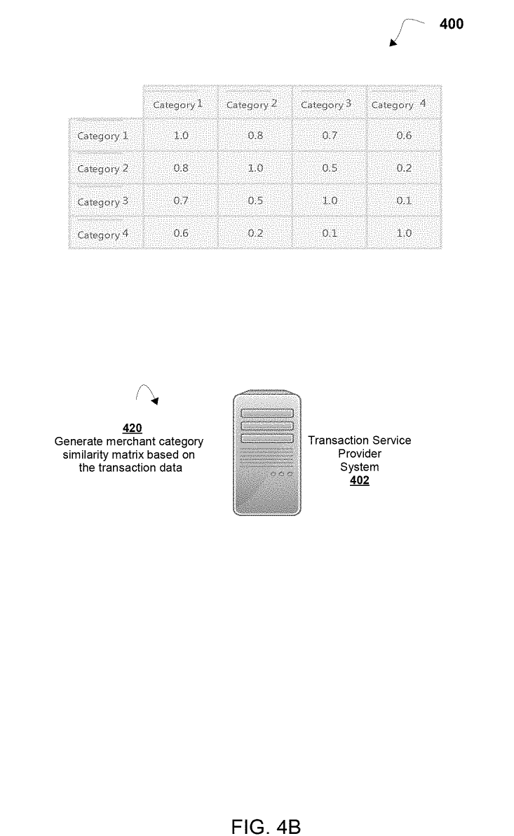

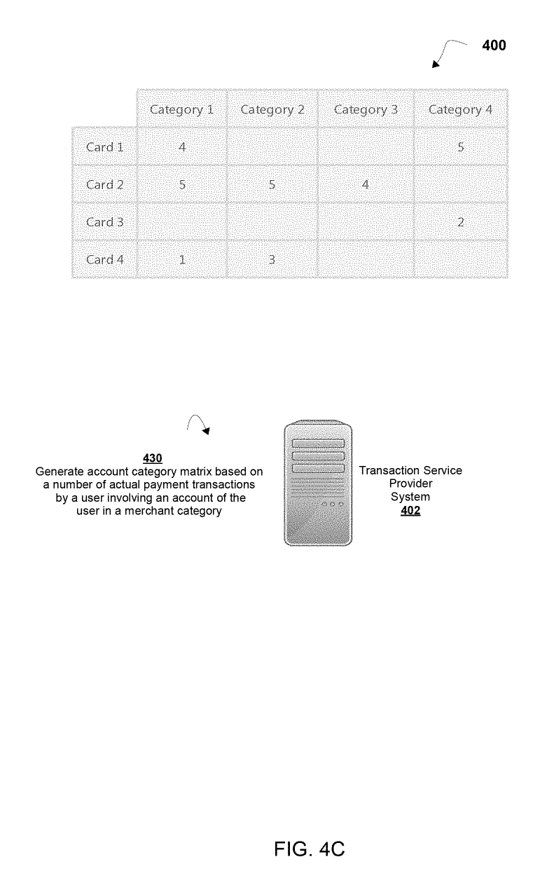

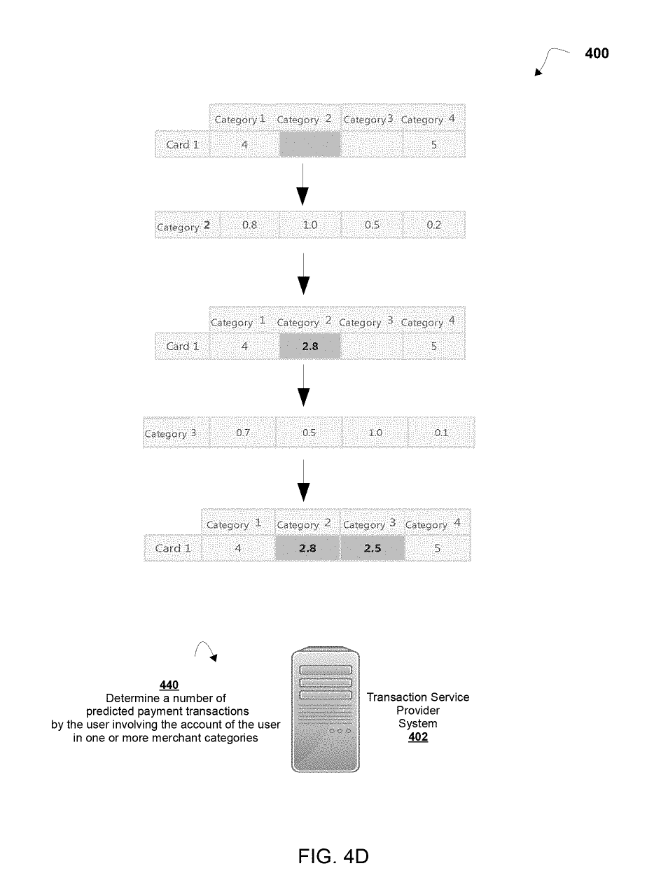

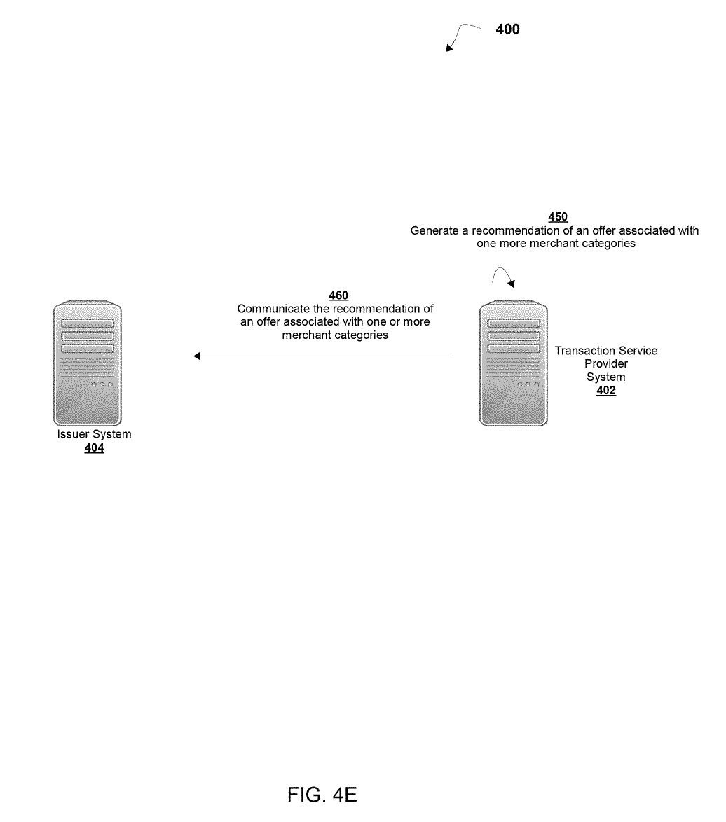

FIGS. 4A-4E are diagrams of an overview of a non-limiting embodiment of an implementation 400 relating to process 300 shown in FIG. 3. As shown in FIGS. 4A-4E, implementation 400 may include a transaction service provider system 402, an issuer system 404 and POS devices 408-1 through 408-N. In some non-limiting embodiments, transaction service provider system 402 may be the same or similar to transaction service provider system 102. In some non-limiting embodiments, issuer system 404 may be the same or similar to issuer system 104. In some non-limiting embodiments, each of POS devices 408-1 through 408-N may be the same or similar to merchant system 108.

As shown by reference number 410 in FIG. 4A, transaction service provider system 402 may receive transaction data associated with a plurality of payment transactions involving a plurality of accounts associated with a plurality of users. For example, transaction service provider system 102 may receive the transaction data from POS devices 408-1 through 408-N based on the plurality of users conducting the plurality of payment transactions at a plurality of merchants (e.g., a plurality of merchants associated with a plurality of merchant categories, a plurality of merchants associated with a plurality of MCCs, and/or the like) associated with POS devices 408-1 through 408-N.

As shown by reference number 420 in FIG. 4B, transaction service provider system 402 may generate a merchant category similarity matrix (e.g., transaction service provider system 402 may generate a merchant category similarity matrix as described above). In some non-limiting embodiments, the merchant category similarity matrix may include an identifier of each merchant category of a plurality of merchant categories on a first axis (e.g., “Category 1,” “Category 2,” “Category 3,” and “Category 4” on the x-axis of the chart as shown in FIG. 4B) and an identifier of each merchant category of a plurality of merchant categories on a second axis (e.g., “Category 1,” “Category 2,” “Category 3,” and “Category 4” on the y-axis of the chart as shown in FIG. 4B). The merchant category similarity matrix may include a plurality of merchant similarity scores for each merchant category of a plurality of merchant categories. For example, a plurality of merchant category similarity scores for “Category 2” includes merchant category similarity scores of 0.8 corresponding to “Category 1,” 1.0 corresponding to “Category 2,” 0.5 corresponding to “Category 3,” and 0.2 corresponding to “Category 4.”

As further shown by reference number 430 in FIG. 4C, transaction service provider system 402 may generate an account category matrix based on the transaction data and/or the merchant category matrix. In some non-limiting embodiments, the account category matrix may include a plurality of account identifiers of a plurality of accounts on a first axis (e.g., “Card 1,” “Card 2,” “Card 3,” and “Card 4” on the y-axis of the chart as shown in FIG. 4C) and an identifier of each merchant category of the plurality of merchant categories (e.g., a merchant category identifier, a MCC, and/or the like) on a second axis (e.g., “Category 1,” “Category 2,” “Category 3,” and “Category 4” on the x-axis of the chart as shown in FIG. 4C). In some non-limiting embodiments, transaction service provider system 102 may generate the account category matrix based on a number of actual payment transactions by a user involving an account of the user in a merchant category of a plurality of merchant categories. For example, a number of actual payment transactions by the user involving an account of the user (e.g., “Card 1” of the user) in “Category 1” is equal to 4. Additionally, a number of actual payment transactions by the user involving the account of the user in “Category 4” is equal to 5. In some non-limiting embodiments, if no payment transactions were conducted by the user involving the account of the user in a merchant category, a number of actual payment transactions by the user in the merchant category may be equal to zero.

As shown by reference number 440 in FIG. 4D, transaction service provider system 402 may determine a number of predicted payment transactions by the user involving the account of the user in one or more merchant categories of the plurality of merchant categories of the account category matrix. For example, transaction service provider system 402 may multiply each of the number of actual payment transactions by the user in one or more first merchant categories (e.g., independent of the number of actual payment transactions by the user in a second merchant category) during a predetermined time interval by each merchant category similarity score for a second merchant category in the merchant category similarity matrix (e.g., independent of the merchant category similarity score corresponding to the second merchant category) to produce a set of products. As shown in FIG. 4D, transaction service provider system 402 may multiply 4*0.8, 0*0.5, and 5*0.2 to produce a set of products of 3.2, 0, and 1.0. As shown in FIG. 4D, transaction service provider system 402 may forego multiplying the merchant category similarity score for “Category 2” corresponding to “Category 2”—1.0 by 0.

In the example above, transaction service provider system 402 may add each product of the set of products to produce a weighted average of actual payment transactions. As shown in FIG. 4D, transaction service provider system 402 may add 3.2, 0, and 1.0 to produce a weighted average of actual payment transactions equal to 4.2.

In the example above, transaction service provider system 402 may divide the weighted average of actual payment transactions by a sum of merchant category similarity scores of the merchant category similarity matrix for the second merchant category (e.g., independent of a merchant category similarity score corresponding to the second merchant category) to produce the number of predicted payment transactions for the one or more merchant categories. As shown in FIG. 4D, transaction service provider system 402 may divide 4.2 by the sum of 0.8, 0.5, 0.2 (e.g., 1.5) to produce the number of predicted payment transactions for “Category 2,” which is equal to 2.8. As shown in FIG. 4D, transaction service provider system 402 may forego including a merchant category similarity score for “Category 2” corresponding to “Category 2” (e.g., 1.0) in the sum of merchant category similarity scores of the merchant category similarity matrix for the second merchant category.

As further shown in FIG. 4D, transaction service provider system 402 may determine a number of predicted payment transactions by the user involving the account of the user in “Category 3” of the account category matrix by multiplying 4*0.7, 0*0.5, and 5*0.1 to produce a set of products of 2.8, 0, and 0.5, adding each product of the set of products to produce a weighted average of actual payment transactions in Category 3 equal to 3.3, and dividing 3.3 by the sum of 0.7, 0.5, and 0.1 (e.g., 1.3) to produce the number of predicted payment transactions for “Category 3,” which is equal to 2.5.

As shown by reference number 450 in FIG. 4E, transaction service provider system 402 may generate a recommendation of an offer associated with the one or more merchant categories. For example, transaction service provider system 402 may generate the generate the recommendation of an offer associated with the one or more merchant categories based on determining the number of predicted payment transactions by the user involving the account of the user in the one or more merchant categories of the plurality of merchant categories of the account category matrix.

As shown by reference number 460 in FIG. 4E, transaction service provider system 102 may communicate the recommendation of an offer to issuer system 404. For example, transaction service provider system 102 may communicate the recommendation of an offer to issuer system 404 based on generating the recommendation of an offer.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method for determining a merchant category alignment of an account comprising:
receiving, with at least one processor, transaction data associated with a plurality of payment transactions involving a plurality of users;
comparing, with at least one processor, at least one parameter associated with the transaction data for each user of the plurality of users;
segmenting, with at least one processor, the plurality of users into at least one group of users based on a similarity of the at least one parameter between each user of the at least one group of users;
generating, with at least one processor, a merchant category similarity matrix for the at least one group of users based on the transaction data for each user in the at least one group, the merchant category similarity matrix comprising a plurality of merchant category similarity scores for the at least one group of users in each merchant category of a plurality of merchant categories, wherein the merchant category similarity scores are based on a determination of how likely each user of the at least one group of users is to conduct a payment transaction in a merchant category of the plurality of merchant categories based on that user conducting a payment transaction in another merchant category of the plurality of merchant categories;
generating, with at least one processor, an account category matrix based on the transaction data, wherein the account category matrix comprises a plurality of elements, wherein a plurality of first elements of the account category matrix comprises a number of actual payment transactions by a target user of the at least one group of users using an account identifier associated with an account of the target user in one or more first merchant categories of a plurality of merchant categories during a predetermined time interval, wherein a second element of the account category matrix comprises a number of predicted payment transactions by the target user using the account identifier associated with the account of the target user in a second merchant category of the plurality of merchant categories during the predetermined time interval, and wherein the number of predicted payment transactions is determined based on the number of actual payment transactions by the target user in the one or more first merchant categories, independent of the second merchant category, during the predetermined time interval and a plurality of merchant category similarity scores of the merchant category similarity matrix for the second merchant category, independent of a merchant similarity score corresponding to the second merchant category;
generating, with at least one processor, one or more recommendations of an offer associated with the second merchant category; and
communicating, with at least one processor, the one or more recommendations of an offer associated with the second merchant category to an issuer system.

2. The method of claim 1, wherein generating the one or more recommendations of an offer comprises:
generating one or more recommendations of an offer based on the number of predicted payment transactions by the target user in the second merchant category satisfying a threshold value.

3. The method of claim 1, wherein the account category matrix comprises a third merchant category and a fourth merchant category, and wherein generating the account category matrix comprises:
determining a number of predicted payment transactions by the target user using the account identifier associated with the account of the target user in the third merchant category during the predetermined time interval;
determining a number of predicted payment transactions by the target user using the account identifier associated with the account of the target user in the fourth merchant category during the predetermined time interval; and
wherein generating the one or more recommendations of an offer comprises:
generating one or more recommendations of an offer associated with the third merchant category based on the number of predicted payment transactions by the target user in the third merchant category being greater than the number of predicted payment transactions by the target user in the fourth merchant category.

4. The method of claim 1, wherein the account identifier associated with the account of the target user is a first account identifier associated with a first account of the target user, and wherein the account category matrix comprises one or more third elements, wherein the one or more third elements comprise a number of actual payment transactions by the target user using a second account identifier associated with a second account of the target user in one or more third merchant categories during the predetermined time interval.

5. The method of claim 4, wherein the one or more third elements of the account category matrix comprise a number of predicted payment transactions by the target user using the second account identifier associated with the second account of the target user in one or more fourth merchant categories during the predetermined time interval.

6. The method of claim 5, further comprising:
generating one or more recommendations of an offer associated with the one or more fourth merchant categories; and
communicating the one or more recommendations of an offer associated with the one or more fourth merchant categories to the target user.

7. The method of claim 1, further comprising:
determining the number of predicted payment transactions by the target user using the account identifier associated with the account of the target user in the second merchant category, wherein determining the number of predicted payment transactions comprises:
multiplying each of the number of actual payment transactions by the target user using the account identifier associated with the account of the target user in the one or more first merchant categories during the predetermined time interval, independent of the number of actual payment transactions by the target user using the account identifier associated with the account of the target user in the second merchant category, by each merchant category similarity score for the second merchant category in the merchant category similarity matrix, independent of the merchant category similarity score corresponding to the second merchant category, to produce a set of products;
adding each of the set of products to produce a weighted average of actual payment transactions; and
dividing the weighted average of actual payment transactions by a sum of merchant category similarity scores of the merchant category similarity matrix for the second merchant category, independent of a merchant category similarity score corresponding to the second merchant category to produce the number of predicted payment transactions.

8. The method of claim 1, wherein generating the merchant category similarity matrix comprises:
generating the merchant category similarity matrix based on the equation:
$$sim ( a , b ) = cos ( a , b ) = \frac{\vec{a} \cdot \vec{b}}{‖ \vec{a} ‖ * ‖ \vec{b} ‖}$$
wherein the function “sim (a, b)” represents a similarity between a variable “a” and a variable “b”;
wherein the variable “a” represents a vector that includes a plurality of first payment transaction scores, wherein each first payment transaction score comprises a number of actual payment transactions by a user of the at least one group of users using an account identifier associated with an account of the user in a first payment transaction merchant category of a plurality of payment transaction merchant categories during the predetermined time interval;
wherein the variable “b” represents a vector that includes a plurality of second payment transaction scores, wherein each second payment transaction score comprises a number of actual payment transactions by a user of the at least one group of users using an account identifier associated with an account of the user in a second payment transaction merchant category of the plurality of payment transaction merchant categories during the predetermined time interval;
wherein the similarity between the variable “a” and the variable “b” is calculated by calculating a cosine function of the variable “a” and the variable “b”; and
wherein the plurality of payment transaction merchant categories comprised the plurality of merchant categories.

9. The method of claim 1, wherein the at least one parameter comprises at least one of the following:
a parameter associated with affluence score of a user;
a parameter associated with an age group of a user;
a parameter associated with foreign and domestic travel conducted by a user;
a parameter associated with online engagement of a user;
a parameter associated with a geographic location of a user;
a parameter associated with a time interval between an account enrollment date and a date of a payment transaction that is a most recent payment transaction involving a user;
a parameter associated with a number of merchant category codes that are active for a user; or
any combination thereof.

10. The method of claim 1, wherein the at least one parameter comprises a distance of a residence location of each user of the at least one group of users from a predetermined zip code.

11. A system for determining a merchant category alignment of an account, the system comprising:
at least one processor programmed or configured to:
receive transaction data associated with a plurality of payment transactions involving a plurality of users and a plurality of merchants in a plurality of merchant categories;
determine at least one parameter associated with the transaction data for each user of the plurality of users;
determine at least one group of users of the plurality users based on determining the at least one parameter;
generate a merchant category similarity matrix for the at least one group of users based on the transaction data for each user in the at least one group, the merchant category similarity matrix comprising a plurality of merchant category similarity scores for the at least one group of users in each merchant category of the plurality of merchant categories, wherein the merchant category similarity scores are based on a determination of how likely each user of the at least one group of users is to conduct a payment transaction in a merchant category of the plurality of merchant categories based on that user conducting a payment transaction in another merchant category of the plurality of merchant categories;
generate an account category matrix based on the transaction data and the merchant category similarity matrix, wherein the account category matrix comprises a plurality of elements, wherein a plurality of first elements of the account category matrix comprise a number of actual payment transactions by a target user of the at least one group of users using an account of the target user in one or more first merchant categories of the plurality of merchant categories during a predetermined time interval, wherein a second element of the account category matrix comprises a number of predicted payment transactions by the target user using the account of the target user in a second merchant category of the plurality of merchant categories during the predetermined time interval, wherein the number of predicted payment transactions is determined based on the number of actual payment transactions by the target user in the one or more first merchant categories during the predetermined time interval and the plurality of merchant category similarity scores of the merchant category similarity matrix for the second merchant category; generate one or more recommendations of an offer associated with the second merchant category based on generating the account category matrix; and
communicate the one or more recommendations of an offer associated with the second merchant category to an issuer system associated with an issuer institution that issued the account of the target user.

12. The system of claim 11, wherein the at least one processor is further programmed or configured to:
determine the number of predicted payment transactions by the target user using the account of the target user in the second merchant category, wherein the at least one processor, when determining the number of predicted payment transactions, is programmed or configured to:
multiply each of the number of actual payment transactions by the target user using the account of the target user in the one or more first merchant categories during the predetermined time interval, independent of the number of actual payment transactions by the target user using the account of the target user in the second merchant category, by each merchant category similarity score for the second merchant category in the merchant category similarity matrix, independent of a merchant category similarity score corresponding to the second merchant category, to produce a set of products;
add each of the set of products to produce a weighted average of actual payment transactions; and
divide the weighted average of actual payment transactions by a sum of merchant category similarity scores of the merchant category similarity matrix for the second merchant category, independent of a merchant category similarity score corresponding to the second merchant category to produce the number of predicted payment transactions.

13. The system of claim 11, wherein the at least one processor, when generating the one or more recommendations of an offer, is programmed or configured to:
generate one or more recommendations of an offer based on the number of predicted payment transactions by the target user in the second merchant category satisfying a threshold value of a number of predicted payment transactions.

14. The system of claim 11, wherein the account category matrix comprises one or more third elements, wherein the one or more third elements comprise a second number of actual payment transactions by the target user using a second account of the target user in one or more third merchant categories during the predetermined time interval.

15. The system of claim 14, wherein the one or more third elements of the account category matrix comprise a number of predicted payment transactions by the target user using the second account of the target user in a fourth merchant category during the predetermined time interval.

16. The system of claim 15, wherein the at least one processor is further programmed or configured to:
generate one or more recommendations of an offer associated with the fourth merchant category; and
communicate the one or more recommendations of an offer associated with the fourth merchant category to the target user.

17. A computer program product for determining a merchant category alignment of an account, the computer program product comprising at least one non-transitory computer-readable medium including one or more instructions that, when executed by at least one processor, cause the at least one processor to:
determine at least one parameter associated with transaction data, wherein the transaction data is associated with a plurality of payment transactions involving a plurality of users, wherein determining the at least one parameter comprises determining a value of the at least one parameter for each user of the plurality of users;
determine at least one group of users of the plurality users based on the at least one parameter;
generate a merchant category similarity matrix for the at least one group of users based on the transaction data for each user in the at least one group, the merchant category similarity matrix comprising a plurality of merchant category similarity scores for the at least one group of users in each merchant category of a plurality of merchant categories, wherein the merchant category similarity scores are based on a determination of how likely each user of the at least one group of users is to conduct a payment transaction in a merchant category of the plurality of merchant categories based on that user conducting a payment transaction in another merchant category of the plurality of merchant categories;
generate an account category matrix based on the transaction data, wherein the account category matrix comprises a plurality of elements, wherein one or more first elements of the account category matrix comprise a number of actual payment transactions by a target user of the at least one group of users using an account identifier associated with an account of the target user in one or more first merchant categories of a plurality of merchant categories during a time interval, wherein a second element of the account category matrix comprises a number of predicted payment transactions by the target user using the account identifier associated with the account of the target user in a second merchant category of the plurality of merchant categories during the time interval, wherein the number of predicted payment transactions by the user is determined based on the number of actual payment transactions by the target user in the one or more first merchant categories during the time interval and one or more merchant category similarity scores of the plurality of merchant category similarity scores of the merchant category similarity matrix for the second merchant category;
generate one or more recommendations of an offer associated with the second merchant category; and
communicate the one or more recommendations of an offer associated with the second merchant category to an issuer system associated with an issuer institution that issued the account of the target user.

18. The computer program product of claim 17, wherein the at least one parameter comprises at least one of the following:
a parameter associated with an affluence score of a user;
a parameter associated with an age group of a user;
a parameter associated with foreign and domestic travel conducted by a user;
a parameter associated with online engagement of a user;
a parameter associated with a geographic location of a user;
a parameter associated with a time interval between an account enrollment date and a date of a payment transaction that is a most recent payment transaction involving a user;
a parameter associated with a number of merchant category codes that are active for a user; or
any combination thereof.

19. The computer program product of claim 17, wherein the at least one parameter comprises a distance of a residence location of each user of the at least one group of users from a predetermined zip code.

20. The computer program product of claim 17, wherein the one or more instructions further cause the at least one processor to:
determine the number of predicted payment transactions by the target user using the account identifier associated with the account of the target user in the second merchant category.
